(19) United States
(12) Patent Application Publication
(10) Pub. No.: US 2008/0305299 A1
(43) Pub. Date: Dec. 11, 2008

(54) Explosion-Inhibiting Articles of Manufacture

(75) Inventor: Eduardo Diaz Del Rio Perez, Madrid (ES)

Correspondence Address: David M. McConoughey;Stoll, Miskin & Badie, 350 Fifth Ave. Ste. 4710, New York, NY, 10118-4710, US

(73) Assignee: Fusaco IP, Sarl

(21) Appl. No.: 10/553,663

(22) PCT Filed: Apr. 16, 2004
(86) PCT No.: PCT/IB04/01539

§ 371 Date: Oct. 30, 2007

Related U.S. Application Data
(60) Provisional application No. 60/463,763, filed on Apr. 18, 2003.

(51) Int. Cl. B32B 3/10

(52) U.S. Cl. 428/134

(57) ABSTRACT

Articles of manufacture formed of an apertured sheet material, the sheet material being provided with at least one row of a plurality of polygonal apertures, at least one of said polygonal apertures being irregular with respect to at least one adjacent polygonal aperture, and having physical characteristics comprising; i) a surface area per unit volume of application of at least about 2,000 times the contact surface of flammable fluids contained in a containing vessel, ii) a heat conductivity of at least about 0.025 Cal/cm-sec. Preferably, the inner peripheral length of at least one of said apertures is unequal to the inner peripheral length of at least one adjacent aperture. Further, the article preferably has a compressive yield of not more than about 10 percent.

### CROSS-REFERENCES TO RELATED APPLICATIONS

The benefit of U.S. Patent Application Ser. No. 60/463,763, filed 18 Apr. 2003, is claimed. This application is a continuation of U.S. Patent Application Ser. No. 60/463,763, filed 18 Apr. 2003.

### STATEMENT REGARDING FEDERALLY SPONSORED RESEARCH OR DEVELOPMENT

Not applicable.

### FIELD OF THE INVENTION

The present invention relates to articles of manufacture for inhibiting the explosion of flammable fluids contained in closed containment vessels and, in particular, for inhibiting boiling liquid, expanding vapor explosions.

### BACKGROUND OF THE INVENTION

Previous approaches to inhibiting the explosion of flammable liquid vapors, especially to inhibiting boiling liquid expanding vapor explosions, have failed to take into account the settlement and the compaction of explosion mitigation devices during the service of those devices.

### SUMMARY OF THE INVENTION

The present invention comprises an article of manufacture comprising an apertured sheet material, the sheet material being provided with at least one row of a plurality of polygonal apertures, at least one of said polygonal apertures being irregular with respect to at least one adjacent polygonal aperture, and having physical characteristics comprising
i. a surface area per unit volume of application of at least about 2,000 times the contact surface of flammable fluids contained in a containing vessel,
ii. a heat conductivity of at least about 0.025 Cal/cm-sec.
   Preferably, the inner peripheral length of at least one of the apertures is unequal to the inner peripheral length of at least one adjacent aperture. Further, the article preferably has a compressive yield of not more than about 10 percent.

In another embodiment, the foregoing sheet material is in the form of a cylindrical roll or bale

In a further embodiment, the foregoing sheet material is in the form of a spheroid

### BRIEF DESCRIPTION OF THE DRAWINGS

FIG. 1 is a top plan view of a sheet material for use in the present invention.

FIG. 2 is a side elevation view taken in transverse section along lines 2-2 in FIG. 1 of a sheet material for use in the present invention.

FIG. 3 is a top plan view of an apertured sheet material for use in the present invention.

FIG. 4 is a side elevation view taken in transverse section along lines 4-4 in FIG. 3 of an apertured sheet material for use in the present invention.

FIG. 5 is a side elevation view taken in longitudinal section along lines 5-5 in FIG. 3 of an apertured sheet material for use in the present invention.

FIG. 6 is a top plan view of an expanded, apertured sheet material for use in the present invention.

FIG. 7 is a side elevation view taken in transverse section along lines 7-7 in FIG. 6 of an expanded, apertured sheet material for use in the present invention.

FIG. 8 is a top plan view on an enlarged scale of portion of FIG. 7 of an expanded, apertured sheet material for use in the present invention.

FIG. 9 is a side elevation view taken in transverse section along lines 9-9 in FIG. 8 of an expanded, apertured sheet material for use in the present invention.

FIG. 10 is a top plan view of a waved, expanded, apertured sheet material for use in the present invention.

FIG. 11 is a side elevation view taken in transverse section along lines 11-11 in FIG. 10 of a waved, expanded, apertured sheet material for use in the present invention.

FIG. 12 is a side elevation view taken in longitudinal section along lines 12-12 in FIG. 10 of a waved, expanded, apertured sheet material for use in the present invention.

FIG. 13 is a front perspective view of a cylindrical shape made in accordance with the present invention.

FIG. 14 is a front elevation view of a cylindrical shape made in accordance with the present invention.

FIG. 15 is a top plan view taken in horizontal section along lines 15-15 in FIG. 14 of a cylindrical shape made in accordance with the present invention.

FIG. 16 is a side elevation view of a spheroidal shape made in accordance with the present invention.

### DESCRIPTION OF THE PREFERRED EMBODIMENTS

The present invention comprises, as an article of manufacture, an apertured sheet material, the sheet material being provided with at least one row of a plurality of polygonal apertures, at least one of said polygonal apertures being irregular with respect to at least one adjacent polygonal aperture, and having physical characteristics comprising
i. a surface area per unit volume of application of at least about 2,000 times the contact surface of flammable fluids contained in a containing vessel,
ii. a heat conductivity of at least about 0.025 Cal/cm-sec.
   Preferably, the inner peripheral length of at least one of the apertures is unequal to the inner peripheral length of at least one adjacent aperture. Further, the article preferably has a compressive yield of not more than about 10 percent.

In this way, an apertured sheet material is provided that produces a configuration that is resistant to settling and to compaction. Such an article of manufacture is helpful in inhibiting a flammable fluid explosion in a closed containment vessel containing flammable fluid, particularly in inhibiting a boiling liquid, expanding vapor explosion (or “BLEVE”.)

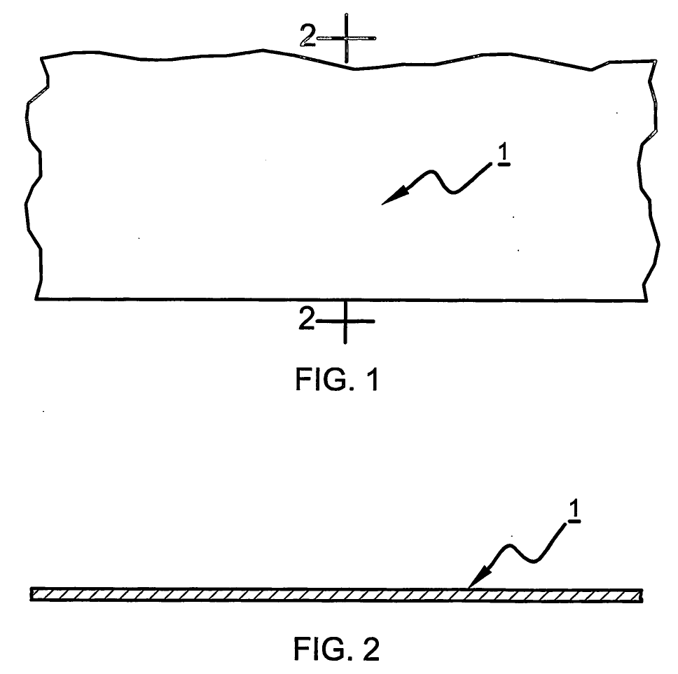

A sheet material for use in the present invention, and as illustrated in FIGS. 1 & 2 by way of example, comprises a sheet 1 of heat-conductive material, preferably having the aforesaid physical properties. The sheet has a flat, generally planar configuration with a thickness from about 0.01 mm (1 micron) to about 0.1 mm (10 microns), desirably from about 0.03 mm (3 microns) to about 0.07 mm (7 microns) and preferably from about 0.04 mm (4 microns) to about 0.05 mm (5 microns).

The sheet material desirably has good heat conductivity in order to adequately dissipate heat in inhibiting the explosion of flammable fluids contained in closed containers, particularly for inhibiting BLEVEs. The heat conductivity should be at least about 0.025 Cal/cm-sec, particularly for materials with a specific density of from about 2.8 g/cm³ to about 19.5 g/cm³, and preferably from about 0.025 to about 0.95 Cal/cm-sec, particularly for materials with a specific density of from about 2.8 g/cm³ to about 19.5 g/cm³

The heat conductivity is nominally about 2.36 Watt/cm-deg (Kelvin) at 273 T.K. (degrees Kelvin) (for Aluminum)—The following can be used as candidate alloy or raw materials depending on the application:

Silver 4.28 Watt/cm-deg (Kelvin) at 273 T.K.,

Gold 3.2018 Watt/cm-deg (Kelvin) at 273 T.K.,

Copper 4.1 Watt/cm-deg (Kelvin) at 273 T.K.,

Stainless Steel 0.835 Watt/cm-deg (Kelvin) at 273 T.K., and

polymeric material

for a material with a density, for example, of 2.7 g/cm³ (Al); 10.5 g/cm³ (Silver), 19.3 g/cm³ (Gold), 8.92 g/cm³ (Copper), 7.86 g/cm³ (Stainless Steel) or 0.9 to 1.5 g/cm³ (polymeric material.

The sheet material is desirably relatively chemically inert to the contents of the closed container for the service life of the container and/or the residence period of the contents in the container. Materials may be metals and metallic alloys, such as aluminum, magnesium, copper, gold, silver or stainless steel, or nonmetallics, such as polymeric or plastic materials.

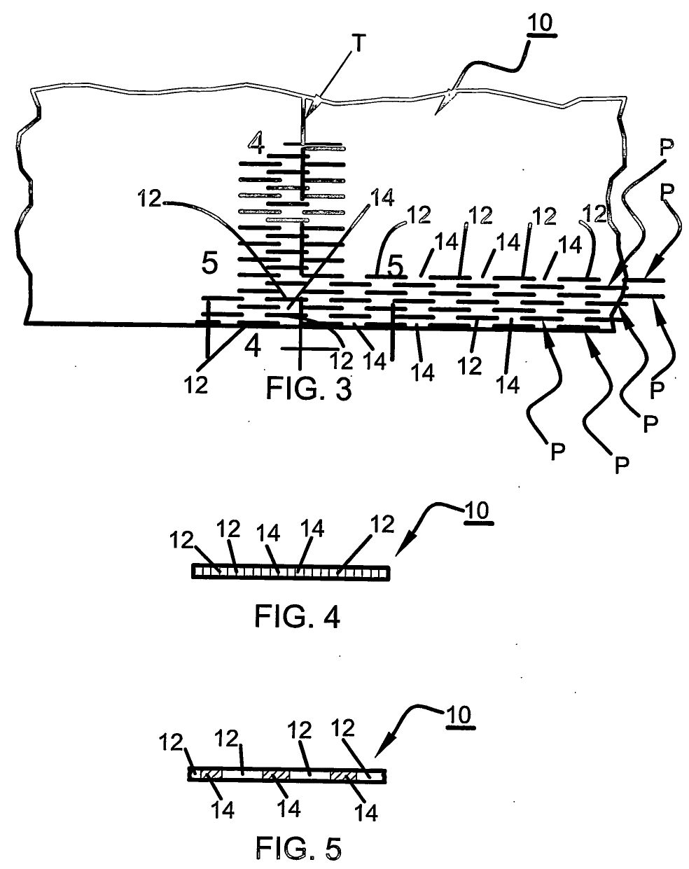

A slit sheet material for use in the present invention, and as is illustrated in FIGS. 3, 4 & 5 by way of example, comprises a sheet material 10 having a plurality of parallel lines P (FIG. 3) of elongated rectangular apertures 12, preferably slots. Each rectangular aperture 12, and each line P of rectangular apertures 12, extends parallel to the longitudinal central axis of the sheet. Each rectangular aperture 12 in a line P of rectangular apertures 12 is spaced from the rectangular aperture 12 preceding it and the rectangular aperture 12 following it by an intermediate web 14 of solid, imperforate sheet material. In other words, in proceeding longitudinally along a line P of rectangular apertures 12, there is a rectangular aperture 12 followed by an intermediate web 14, followed by a rectangular aperture 12 followed by an intermediate web 14, et cetera.

In forming a sheet with polygonal apertures, the intermediate webs 14 of adjacent lines of rectangular apertures are offset with respect to each other so that in proceeding transversely across the sheet along a line T that is perpendicular to the longitudinal central axis of the sheet and that passes through an intermediate web 14 of an adjacent longitudinal line P of rectangular apertures 12,
a. the transverse line T will pass across a rectangular aperture 12 of the next adjacent longitudinal line P of rectangular apertures 12,
b. then through an intermediate web 14 of the next adjacent longitudinal line P of rectangular apertures 12,
c. then across a rectangular aperture 12 of the next adjacent longitudinal line of rectangular apertures, et cetera.

In this way, the longitudinally extending rectangular apertures 12 alternate with intermediate webs 14 transversely across the sheet 10.

Preferably, the length of each longitudinally extending rectangular aperture 12 in proceeding along a transverse line T of rectangular apertures 12 should be different from the length of the rectangular aperture 12 preceding it and the length of the rectangular aperture 12 following it. In other words, the length of each longitudinally extending rectangular aperture 12 is preferably different from the length of the next adjacent longitudinally extending rectangular aperture 12 in a transverse line T across the width of the sheet. Further, with respect to each rectangular aperture 12, the length of each of the four most adjacent rectangular apertures 12 in the two most adjacent longitudinal lines P of rectangular apertures 12 should preferably also be different from that of the rectangular aperture 12.

The lengths of the respective longitudinally extending rectangular apertures 12 in a transverse line T across the width of the sheet may be random with respect to each other. Alternatively, the lengths of each respective longitudinally extending rectangular aperture 12 may increase progressively in length in a transverse line T across the width of the sheet or decrease in length. In one alternative embodiment, the lengths of each respective longitudinally extending rectangular aperture 12 increase progressively in length in a transverse line T across the width of the sheet and the lengths of each respective longitudinally extending rectangular aperture 12 in the next adjacent transverse line T decreases progressively in length across the width of the sheet.

The length of the apertures 12 is nominally from about 10 to about 15 mm., desirably from about 12 mm. to about 15 mm., and preferably, from about 13 mm. to about 15 mm. In this way, an aperture of 10 mm. might be followed by one of 10.033 mm, followed by one of 10.06 mm. The width of each rectangular aperture, or slot, may be from about 0.02 mm. to 0.06 mm, desirably from about 0.03 mm. to about 0.05 mm., and, preferably, from about 0.04 mm. to about 0.05 mm. The spacing between the rows of apertures may be varied based on the properties of the material used for the sheet.

The intermediate web between apertures, in turn, is from about 2.5 mm to about 4.5 mm. In this way, an intermediate web of 3 mm. might be followed by one of 3.5 mm, followed by one of 4 mm.

In this way, irregularity is induced in the expanded apertured sheet that produces configurational resistance to settling and compaction.

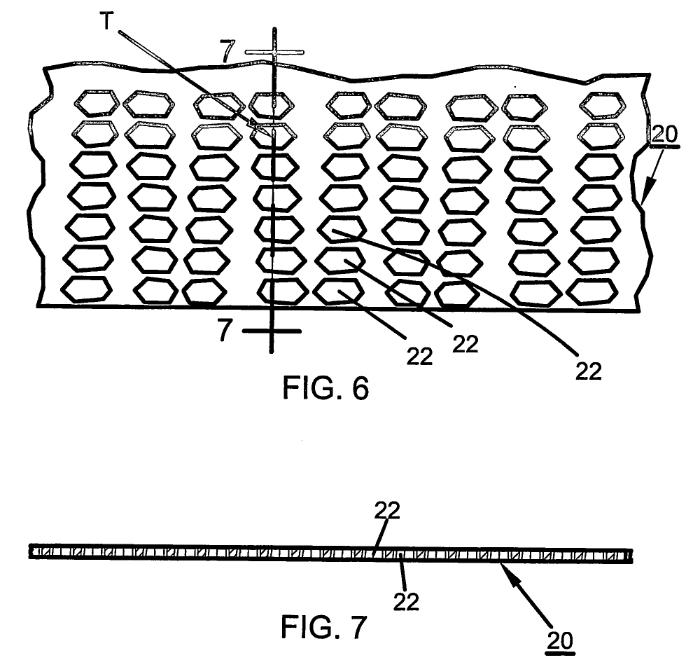

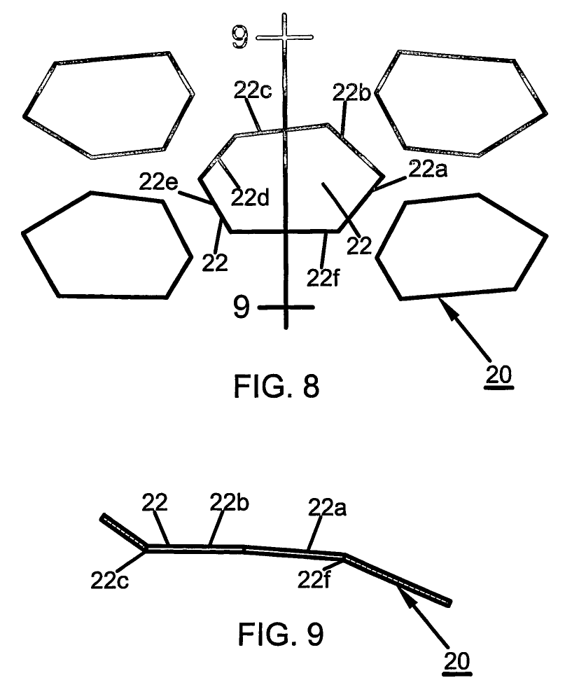

A slit sheet material for use in the present invention, and as illustrated in FIGS. 6 through 9 by way of example, is converted into an expanded, apertured (or fenestrated) sheet material 20 of the present invention that is provided with a plurality of many-sided, or polygonal apertures 22, such as, for example and as illustrated, hexagonal apertures. At least one polygonal aperture is irregular with respect to at least one adjacent polygonal aperture.

For example, the sum of the lengths of the inner edges of the sides of a polygonal aperture 22, for example lengths 22a, 22b, 22c, 22d, 22e, and 22f in FIG. 9, determine an inner peripheral length of a polygonal aperture 22. The inner peripheral length of each polygonal aperture 22 in proceeding along a transverse line T of polygonal apertures 22 should be different from the inner peripheral length of the polygonal aperture 22 preceding it and the inner peripheral length of the polygonal aperture 22 following it. In other words, the inner peripheral length of each polygonal aperture 22 is different from the inner peripheral length of the next adjacent polygonal aperture 22 in a transverse line across the width of the sheet. Further with respect to each polygonal aperture 22, the inner peripheral length of each of the four most adjacent polygonal apertures 22 in the two most adjacent longitudinal lines of polygonal apertures 22 should preferably also be different from that polygonal aperture 22.

The inner peripheral lengths of the respective polygonal apertures 22 in a transverse line T across the width of the sheet may be random with respect to each other. Alternatively, the inner peripheral lengths of each respective polygonal aperture 22 may increase progressively in inner peripheral length in a transverse line T across the width of the sheet or decrease. In one alternative embodiment, the inner peripheral lengths of each respective polygonal aperture 22 increase progressively in length in a transverse line T across the width of the sheet and the inner peripheral lengths of each respective polygonal aperture 22 in the next adjacent transverse line T decrease progressively in length across the width of the sheet.

The term “irregular” as it is used herein in the context of the inner peripheral length of at least one of said apertures being unequal to the inner peripheral length of at least one adjacent aperture means that the numerical value of the inequality of one inner peripheral length with respect to the other inner peripheral length is greater than the variation in inner peripheral length produce by manufacturing variation or manufacturing tolerance. In other words, the inequality is intentional rather than random or inherent manufacturing variation.

While the irregularity of at least one polygonal aperture with respect to at least one adjacent polygonal aperture has been described in terms of the inner peripheral length of at least one of said apertures being unequal to the inner peripheral length of at least one adjacent aperture, it should be understood that irregularity can also be produced in other ways, such as having a different number of sides on the polygon (such as a pentagon or a heptagon versus a hexagon) or the length of a side of a polygonal aperture being different from the corresponding side of an adjacent polygonal aperture (i.e., greater than manufacturing variation or tolerance as previously stated) or the angle between two adjacent sides of a polygonal aperture being different from the corresponding angle between the corresponding two sides of an adjacent polygonal aperture. For example, the respective lengths of the side edges of the apertures may not all be equal, i.e., at least one side may not be the same length as any of the other sides, thereby providing an aperture with a configuration such as an irregular polygon.)

In this way, when multiple expanded, apertured sheets are placed on top of each other, they are unable to align polygonal apertures and nest into each other, settling and thereby reducing the effective thickness of the multiple sheets 20.

The expanded, apertured (or fenestrated) sheet material 20 of the present invention desirably has a compression yield, or resistance to compaction (i.e., permanent deformation under compressive load), of not more than 10 percent. Ideally, however, there is essentially no compressive yield in service.

The expanded, apertured sheet material 20 is formed by tensioning slotted sheet material 10 over large wheel of a varying diameter positioned in such a way as to regulate the spreading of the sheet material to an additional width 50% to 100% that of the raw sheet material width so as to ensure the resulting openings form a plurality of polygonal apertures 22 as aforesaid.

The expanded, apertured sheet material 20 desirably has an effective surface area per unit volume from at least about 2,000 times the contact surface of flammable liquid/vapors and gases contained in closed containers, particularly for inhibiting boiling liquid, expanding vapor explosions, and preferably from at least about 3,000 times the contact surface of flammable liquid/vapors and gases contained in closed containers. The term “contact surface” refers to the surface area of the containment vessel that is in contact with the gaseous, aerosol or vapor phase of the flammable fluid that is contained in the containment vessel. Normally the flammable fluids (liquid, vapor, aerosol or gas) are in contact with the surface areas of the walls of the container containing the flammable fluid. The insertion of the finished expanded, apertured sheet material increases the surface area of contact with the flammable fluid by at least about 2,000 times this contact surface area, preferably at least about 3,000 times this contact surface area. This ratio is significant and to compromise this proportion of contact relative to the specific fluid in question is to risk a BLEVE. This area varies in relation to the heat conductivity and compressive yield strength of the material used.

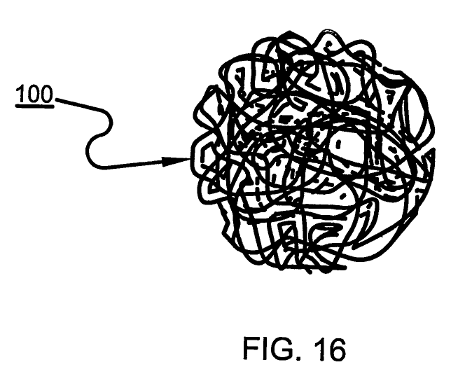

In one embodiment, expanded, apertured sheet material 20 for use in the present invention, and as is illustrated in FIG. 16 by way of example, may be formed into a shape that comprises a body 100 with a generally spheroidal external configuration or shape.

The internal configuration of the generally spheroidal body 100 comprises at least one strip of the aforesaid expanded, expanded sheet material that is folded and/or crimped and cupped to form said spheroidal shape. The generally spheroidal shape may be formed using a section of expanded, apertured sheet material of a size proportional to about 20% of the width of the expanded, apertured sheet material.

The outer spherical periphery of the spheroid 100 encloses a volume. The surface area of the material contained within this periphery, i.e., inside the spheroid, subject to the application design requirement, is at least about 1.5 square centimeters per cubic centimeter of said volume or larger as required, The surface area of the material should be at least about 2,000 times the contact surface of flammable fluid contained in the enclosing container of those flammable fluid, particularly for inhibiting BLEVEs.

The spheroid 100 desirably has a compression yield, or resistance to compaction (i.e., permanent deformation under compressive load), of not more than 10 percent. Ideally, however, there is essentially no compressive yield in service.

The structural strength of the final product can also be modified by using a different heat hardness in the sheet material.

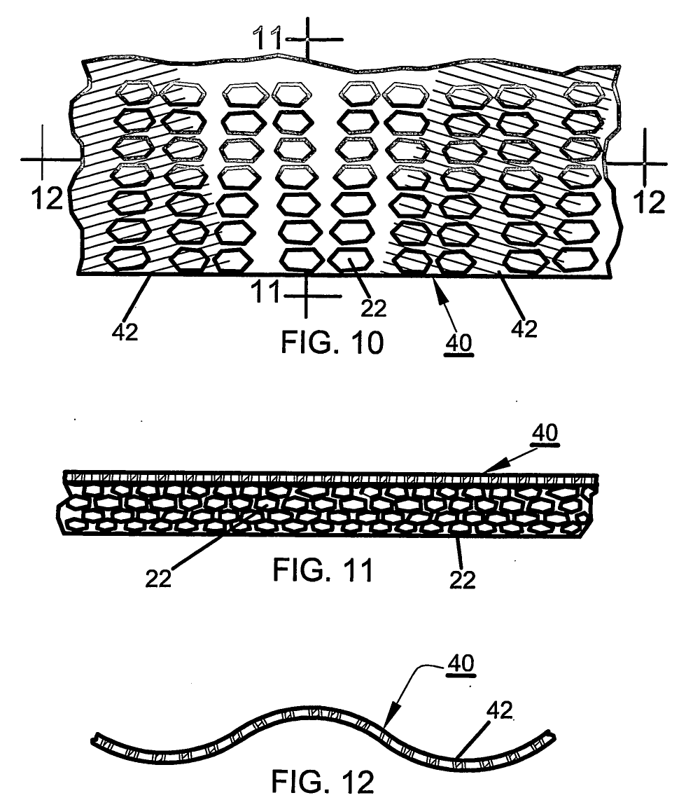

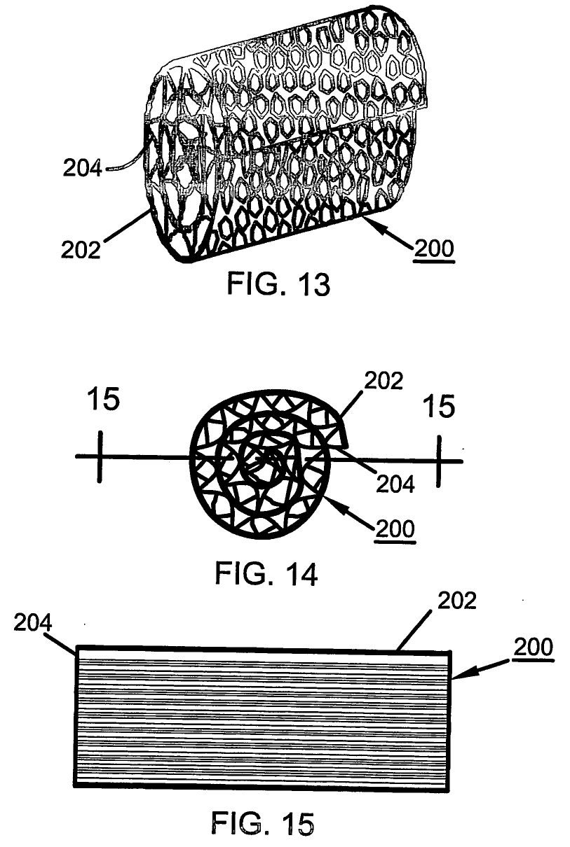

In an alternative embodiment of the present invention, expanded, apertured sheet material 20 for use in the present invention, and as illustrated in FIGS. 10 through 12 by way of example, is provided with a transverse undulating, or sinusoidal, wave 42 formed in it and the waved, expanded, apertured sheet material 40, as illustrated in FIGS. 13 through 15 by way of example, is helically wound into a cylindrical shape 200, such as a cylindrical bale. The cylindrical shape 200 is generally circular in transverse section (FIG. 14) and generally rectangular in longitudinal section (FIG. 15.) In a further form of this cylindrical embodiment, a flat expanded, apertured sheet material may be wound into the cylindrical form. In a still further form (FIGS. 13-15) of this cylindrical embodiment, a sheet of flat expanded, apertured sheet material 202 and a sheet of waved, expanded, apertured sheet material 204 may be wound into the cylindrical form, thereby forming alternate layers of flat and waved expanded, apertured sheet material in the cylindrical shape.

Because of the wave 42 formed in the sheet material 40, with the sheet material 40 helically wound, the wave 42 causes an increase in the effective diameter of the cylinder 200. In this way, the effective surface area contained within a given outer periphery of the cylinder 200 is increased. This provides large included volume cylinders 200 with low mass and high internal effective area.

The cylinder 200 desirably has a compression yield, or resistance to compaction (i.e., permanent deformation under compressive load), of not more than 10 percent. Ideally, however, there is essentially no compressive yield in service.

The imperforate starting sheet material 1 may be supplied as a continuous, non-perforated web of sheet material. Then, rectangular apertures 12, or slots, are formed in the continuous web in the aforesaid configuration, such as by slitting. Then, the slotted web 10 may be expanded transversely by tensioning the sheet material 10 transversely, such as over a wheel positioned in such a way as to regulate the spreading of the sheet material to an additional width 50% to 100% that of the raw sheet material width so as to ensure the resulting openings form a plurality of polygonal apertures 22 of irregularity as aforesaid. Adjusting the position and tension of the expanding wheel on the production machine does this. By doing this, the result is the ability to have the walls of the finished honeycomb pattern more or less more erect, thereby increasing the compressive strength of the finished expanded, apertured sheet material 20.

Optionally, the expanded, apertured web 20 may have a sinusoidal transverse wave 42 formed in it. The form of the wave 42 is introduced or impressed into the lengths of the sheet material 20 as a series of transverse kinks or waves 42 along the length of the web that looks like waves when the finished product is spooled.

Cylindrical shapes 200 may be formed by winding the aforesaid expanded, apertured sheet material.

Spheroid shapes 100 may be made by feeding the sheet material 20 provided with a plurality of rows of a plurality of parallel apertures 22, the longitudinal central of each being parallel to the longitudinal central axis of the sheet, into a machine using a mechanical device comprising two semi-circular rimmed sections with the working sections opposing each other. One is a stationary semi circular die of a variable radius with a concave working edge. The other is a rotating 360 degree circular die with a concave working edge with a friction surface. The rotation of the circular die against the fixed die forms the sheet material into a tube shape. As the sheet material is drawn through the aperture formed by the interfacing of the circular die rotating against the fixed die, the rotating die grabs a length of sheet material, determined by the material volume required for the diameters of the two semi-circular rimmed sections of the dies. and tumbles the expanded sheet material into a generally spheroidal shape.

The expanded, apertured sheet material of the present invention may be used in the following applications:
1. Cylinders of expanded, apertured sheet material (netting) loaded into large closed vessels, tanks, cans, drums, bulk carriers, fuel tanks of all description, pipe lines, piping, tubing, construction, insulation and in other applications where flammable fluids, such as, flammable liquids, vapors, aerosols or gases are used, stored, or transported;
2. Spheroids of expanded, apertured sheet material loaded as spheroids into small closed vessels, gas cylinders, gas bottles, fuel tanks of all description, bulk carriers, construction, insulation and in other applications where flammable fluids, such as flammable liquids, vapors, aerosols or gases are, used, stored or transported;
3. Solar panels; 4. Insulation; 5. Construction material; 6. Sound proofing; 7. Cooling elements for computer equipment; 8. Filters; 9. Heat Exchangers; 10. Fire-proof cloth; 11. Fire-retardants; 12. Aircraft; 13. Refineries; 14. Pipelines; 15. Gasoline stations; 16. Gas tanks and gas cylinders; 17. Gas vehicles; and 18. Bulk fluid carriers and vessels.

What is claimed is:

1. An explosion-inhibiting article of manufacture comprising an apertured sheet material, said sheet material
a. being provided with at least one row of a plurality of polygonal apertures, at least one of said polygonal apertures being irregular with respect to at least one adjacent polygonal aperture,
and
b. having physical characteristics comprising
i. a surface area per unit volume of application of at least about 2,000 times the contact surface of flammable fluids contained in a containing vessel, and
ii. a heat conductivity of at least about 0.025 Cal/cm-sec.

2. An explosion-inhibiting article of manufacture in accordance with claim 1, wherein the inner peripheral length of at least one of said apertures is unequal to the inner peripheral length of at least one adjacent aperture.

3. An explosion-inhibiting article of manufacture in accordance with claim 1, wherein the material has a density from about 2.8 g/cm³ to about 19.5 g/cm³.

4. An explosion-inhibiting article of manufacture in accordance with claim 1, wherein said article has a compressive yield of not more than about 10 percent.

5. An explosion-inhibiting article of manufacture having a generally spheroidal shape and comprising an apertured sheet material, said sheet material
a. being provided with at least one row of a plurality of polygonal apertures, at least one of said polygonal apertures being irregular with respect to at least one adjacent polygonal aperture,
and
b. having physical characteristics comprising
i. a surface area per unit volume of application of at least about 2,000 times the contact surface of flammable fluids contained in a containing vessel, and
ii. a heat conductivity of at least about 0.025 Cal/cm-sec.

6. An explosion-inhibiting article of manufacture in accordance with claim 5, wherein the inner peripheral length of at least one of said apertures is unequal to the inner peripheral length of at least one adjacent aperture.

7. An explosion-inhibiting article of manufacture in accordance with claim 5, wherein the material has a density from about 2.8 g/cm³ to about 19.5 g/cm³.

8. An explosion-inhibiting article of manufacture in accordance with claim 5, wherein said article has a compressive yield of not more than about 10 percent.

9. An explosion-inhibiting article of manufacture having a generally cylindrical shape and comprising an apertured sheet material, said sheet material
a. being provided with at least one row of a plurality of polygonal apertures, at least one of said polygonal apertures being irregular with respect to at least one adjacent polygonal aperture,
and
b. having physical characteristics comprising
i. a surface area per unit volume of application of at least about 2,000 times the contact surface of flammable fluids contained in a containing vessel, and
ii. a heat conductivity of at least about 0.025 Cal/cm-sec.

10. An explosion-inhibiting article of manufacture in accordance with claim 9, wherein the inner peripheral length of at least one of said apertures is unequal to the inner peripheral length of at least one adjacent aperture.

11. An explosion-inhibiting article of manufacture in accordance with claim 9, wherein the material has a density from about 2.8 g/cm³ to about 19.5 g/cm³.

12. An explosion-inhibiting article of manufacture in accordance with claim 9, wherein said article has a compressive yield of not more than about 10 percent.

13. An explosion-inhibiting article of manufacture comprising an apertured sheet material, said sheet material
a. being provided with at least one row of a plurality of polygonal apertures,
and
b. having physical characteristics comprising
i. a surface area per unit volume of application of at least about 2,000 times the contact surface of flammable fluids contained in a containing vessel, and
ii. a heat conductivity of at least about 0.025 Cal/cm-sec,
said article having a compressive yield of not more than about 10 percent.

14. An explosion-inhibiting article of manufacture having a generally spheroidal shape and comprising an apertured sheet material, said sheet material
a. being provided with at least one row of a plurality of polygonal apertures,
and
b. having physical characteristics comprising
i. a surface area per unit volume of application of at least about 2,000 times the contact surface of flammable fluids contained in a containing vessel, and
ii. a heat conductivity of at least about 0.025 Cal/cm-sec,
said article having a compressive yield of not more than about 10 percent.

15. An explosion-inhibiting article of manufacture having a generally cylindrical shape and comprising an apertured sheet material, said sheet material
a. being provided with at least one row of a plurality of polygonal apertures,
and
b. having physical characteristics comprising
i. a surface area per unit volume of application of at least about 2,000 times the contact surface of flammable fluids contained in a containing vessel, and
ii. a heat conductivity of at least about 0.025 Cal/cm-sec,
said article having a compressive yield of not more than about 10 percent.
